(19) United States
(12) Patent Application Publication
(10) Pub. No.: US 2016/0322880 A1
(43) Pub. Date: Nov. 3, 2016

(54) LAMINATED-BARREL STRUCTURE FOR USE IN A STATOR-TYPE POWER GENERATOR

(71) Applicant: GE Energy Power Conversion Technology Ltd, Rugby (GB)

(72) Inventor: Stuart BRADLEY, Lutterworth (GB)

(21) Appl. No.: 15/142,587

(22) Filed: Apr. 29, 2016

(30) Foreign Application Priority Data
Apr. 30, 2015 (GB) 1507407.3

(51) Int. Cl. H02K 5/24; H02K 1/27; H02K 1/14

(52) U.S. Cl. CPC H02K 5/24; H02K 1/146; H02K 1/27

(57) ABSTRACT

A laminated-barrel structure for use in a permanent-magnet power-generation system is described. The structure includes a rigid outer ring, a rigid inner ring being concentric with and positioned within the rigid outer ring, and a damping intermediate ring positioned between the rigid outer ring and the rigid inner ring. The intermediate ring can include polymer and the rigid rings can include metal. The rigid inner ring can include recesses for receiving stator components of the power-generation system.

### TECHNICAL FIELD

The present disclosure relates generally to power generation. More particularly, the present disclosure relates to a laminated-barrel structure for use in a permanent-magnet power generator.

### BACKGROUND

Large direct-drive permanent magnet generators are used to generate power in applications such as wind turbines. These direct-drive permanent magnet generators include bulky and heavy stator structures or frames.

The large-scale stator frames must withstand operational inputs including shock, torsion, and vibrations. Conventional stators are at times unable to absorb the inputs, as needed, and resonate undesirably. Unwanted resonation can result especially when the stator is even slightly misaligned, or its mass misdistributed.

The unwanted resonation may create at least intermittent noise pollution to an environment in which the generator is used (e.g., a city neighborhood or country side), and can harm generator components and intra-generator connections over time.

Attempts to alleviate these problems have included adding stiffeners or mass to the stator strategically to increase stator strength and stiffness. A relatively-large circular part can be added measuring, e.g., many meters in diameter.

A shortcoming of these approaches is a high expense for materials and parts (e.g., stiffener or mass), by manufacture or purchase. Installation can also be expensive in terms of tooling, energy, and time, as the new part must be positioned and matched exactly adjacent existing components for connection. Added mass can also reduce subsequent system efficiency and maneuverability.

### BRIEF DESCRIPTION

Given the aforementioned deficiencies, there is a need for a stator or adjacent-stator component for use in a direct-drive permanent magnet generator, or other electrical machine topologies, such as synchronous machines, to eliminate unwanted resonance.

The present technology meets the referenced need by a method for forming a laminated-barrel structure that, when in use in a stator-based power generator, reduces overall stator mass, therein, increasing a second moment of area of the stator, and increasing vibration-absorbing properties.

The stator system of the present technology can withstand the aforementioned operational inputs including shocks, torsions, and vibrations, thereby eliminating and at least greatly reducing system noise.

The manufacturing method in some embodiments includes forming desired components and inter-component connections using any of the fixtures, molds, alignment tools, and forming tools described herein. The new structure is made by forming or obtaining required components, aligning them appropriately for connection and securing them in place in the power generator.

With the present technology, the aligning sub-process is relatively easy. Moreover, the resulting structure is more tolerant than prior systems, of slight misalignments occasioned in manufacture, transport, installation, use, or maintenance.

The method involves adding to, or adjacent, active stator parts (e.g., tooth-windings), a multi-level, relatively light-weight, supporting structure. The structure in one embodiment comprises a laminated steel-polymer (e.g., polyurethane)-steel (S-P-S) barrel, or other rigid-damping-rigid (R-D-R) ring arrangement, forming a primary stator component.

The barrel can be referred to as laminated due to the inner ring (e.g., steel) being laminated by the adjacent vibration damping ring—e.g., polyurethane resin. The damping ring is in turn held in during formation, and protected during operation, by the outer hard, or rigid, ring including, e.g., steel.

In an alternative embodiment, the structure includes a steel-polyurethane-steel-polyurethane-steel (S-P-S-P-S) barrel, or other rigid-damping-rigid-damping-rigid (R-D-R-D-R) ring arrangement. In a particular implementation, the arrangement includes a relatively thick inner layer of steel and two thinner steel laminates separated by relatively thicker polymer sections.

The barrel increases a second moment of area of the stator portion of the power generator, without adding a large mass to the stator-based generator. Even relatively-slight increases in the second moment of area of the stator portion of the power generator increase stator stiffness greatly.

Further features and advantages, as well as the structure and operation of various embodiments, are described in detail below with reference to the accompanying drawings. The technology is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

Exemplary embodiments may take form in various components and arrangements of components. Exemplary embodiments are illustrated in the accompanying skematic drawings, throughout which like reference numerals may indicate corresponding or similar parts in the various figures. The drawings are provided for purposes of illustrating exemplary embodiments only and are not to be construed as limiting the technology. Given the following enabling description of the drawings, unique aspects of the present technology will be evident to a person of ordinary skill in the art.

FIG. 1 is a perspective view of a barrel structure according to an embodiment of the present technology.

FIG. 2 is a cross-sectional view of the barrel structure, taken along line 2-2 in FIG. 1.

FIG. 3 is a cross-sectional view, like that of FIG. 2, of an alternative barrel structure.

FIG. 4 is a cross-sectional view of the barrel structure, taken along line 4-4 in FIG. 1.

FIG. 5 is a cross-sectional view, like FIG. 4, showing the barrel structure installed with other parts of a stator system.

FIG. 6 is a flow chart showing steps for making the barrel structure of the present technology.

FIG. 7 is a side cross-sectional view, like FIG. 2, showing a stage of manufacturing the barrel structure in which a mold is used.

FIG. 8 shows an improved vibration response curve from operation of the present technology as compared to a curve of a conventional system.

FIG. 9 is a cross-sectional view, like FIG. 4, of a prior art device.

FIG. 10 is a cross-sectional view, like FIG. 5, of the prior art device.

### DETAILED DESCRIPTION

While exemplary embodiments are described herein with illustrative embodiments for particular implementations, it should be understood that the technology is not limited thereto. Those skilled in the art with access to the teachings provided herein will recognize additional modifications, applications, and embodiments within the scope thereof, and additional fields in which the barrel structure described herein would be of significant utility.

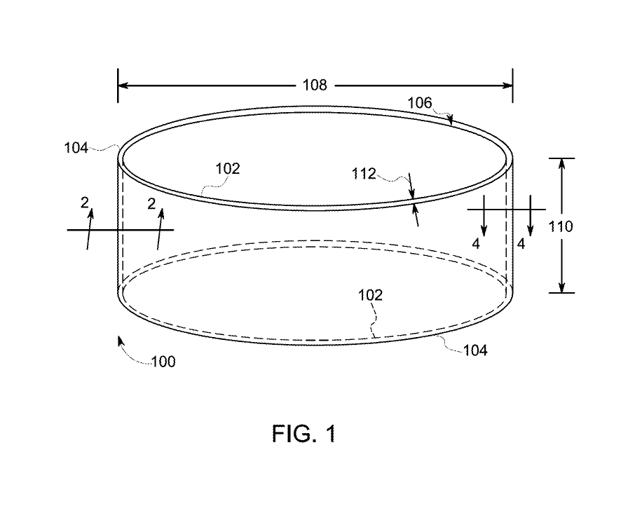

Now turning to the figures, and more particularly the first figure, FIG. 1 is an skematic illustration of a barrel structure 100 for use with a stator system of a power generator. The power generator can be, for instance, a direct-drive permanent magnet generator (DD PMG).

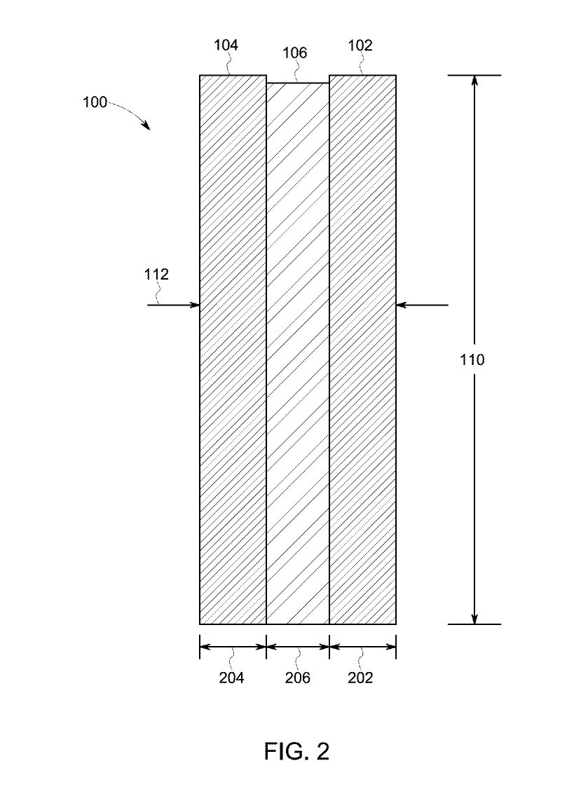

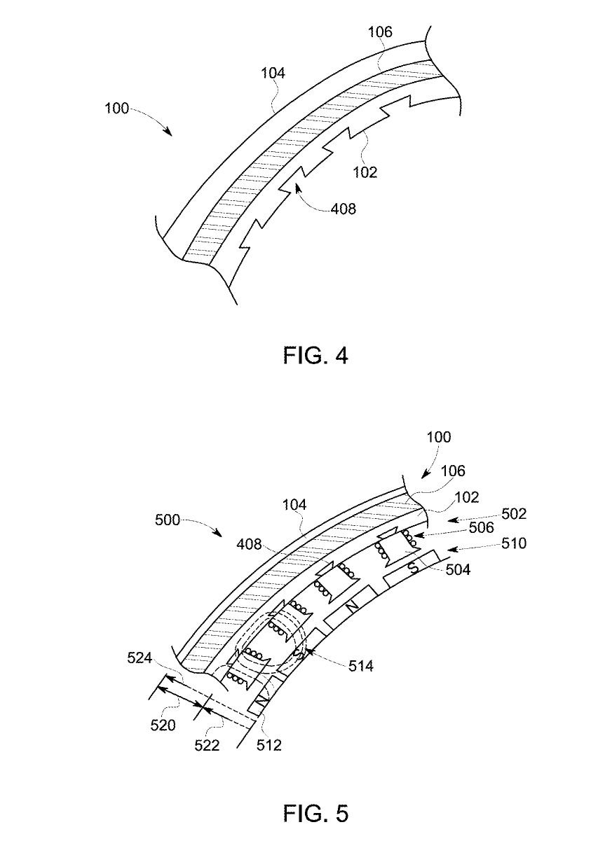

The barrel structure 100 includes an inner component, or ring, 102, an outer component, or ring, 104, and an intermediate component, or ring, 106. The intermediate ring 106 is shown in greater detail in FIGS. 2 and 4.

The barrel structure 100 has a generally cylindrical top profile. Although the structure 100 can have other outer diameters 108 without departing from the present technology, in one embodiment the structure 100 has an outer diamter of between about 3 and about 6 meters. In one embodiment, the outer diameter is between about 4 to 5 meters, and in a another embodiment the outer diameter is greater than 4 meters.

While the structure 100 can have other heights 110 without departing from the present technology, in one embodiment the structure 100 has a height 110 of between about 1 and 3 meters, and a thickness of between about 30 mm and about 150 mm.

While the rings of the barrel structure 100 can have other thicknesses without departing from the scope of the present technology, in various embodiments, the inner ring 102 has a thickness (202 in FIG. 2) of between about 10 mm and about 50 mm, the outer ring 104 has a thickness (204 in FIG. 2) of between about 10 mm and about 50 mm, and the intermediate damping ring 106 has a thickness (306 in FIG. 2) of between about 10 mm and about 50 mm.

The present barrel structure 100 is configured (e.g., rings sized and positioned, and material selected) to increase a second moment of area of the stator. The second moment of area of the stator can be represented by Iₓ=π/2 (rₒ⁴−rᵢ⁴), wherein rᵢ is an inner radius, measured between a centerline of the stator (and so also the centerline of the rings and rotor), and the inner ring 102 (the inner radius rᵢ being labeled 522 in FIG. 5), and rₒ is an outer radius, measured between a centerline of the stator (and so also the centerline of the rings and rotor) and the outer rotor (the outer radius rₒ being labeled 524 in FIG. 5).

As an example of an increased second moment of area of the stator, the barrel structure 100 is configured so that the second moment of area is above about 2 m⁴.

FIG. 2 provides a cross-sectional view of the barrel structure, taken along line 2-2 in FIG. 1. The inner and outer rings 102, 104 of FIG. 1 are shown separated by an intermediate ring 106. While the rings may go by other names, for ease of description, the inner and outer rings 102, 104 can be referred to as hard or rigid rings of the barrel 100, being made of steel, another metal, an alloy, etc. The intermediate ring 106 can be referred to as a damping ring, or a soft ring being softer, or less rigid, than the hard/rigid ring.

The barrel structure 100 can include any of a variety of materials without departing from the present technology. The inner and/or outer barrel components 102, 104 can include a metal such as steel, another metal or alloy, or an non-metal material.

Each hard ring 102, 104 can be different in one or more ways other than the diameters—e.g., they can have different heights, thicknesses, and/or include different materials (e.g., metals or compounds).

The barrel structure 100 is in some embodiments configured for use with an inner-rotor power generator. In these embodiments, the inner ring 102 is connected to stator parts (e.g., stator teeth) adjacent and opposite the inner rotor. The arrangement is shown in FIG. 5, and described further below. In this arrangement, the inner ring material and size (e.g., thickness) are selected so that the inner ring 102 would complete as needed the electromagnetic circut created by stator/rotor flux, in power generation during operation of the generator. In this embodiment, the outer ring 104 can be made from a fairly thin section—e.g., between about 10-50 mm, as mentioned above.

In a contemplated embodiment, the barrel structure is configured for use with an outer-rotor power generator (not shown in detail). In this embodiment, the outer ring 104 is connected to stator parts (e.g., stator teeth) adjacent and opposite the outer rotor. In this case, the outer ring material and size (e.g., thickness) are selected so that the outer ring 104 would complete as needed the electromagnetic circut created by stator/rotor flux, in power generation during operation of the generator. In this case, also, the inner ring 102 can be made from a fairly thin section—e.g., between about 10-50 mm, as mentioned.

The intermediate ring 106 can include any of a wide variety of materials without deparating from the present technology. In one embodiment, the intermediate ring 106 includes a polyurethane resin. The intermediate ring 106 can include another polymer and be referred to as a polymer ring 106.

In one embodiment, the intermediate ring 106 includes at least one of a elastic polymer, a thermoplastic, a thermoset material, and an elastic material.

In another embodiment, the intermediate ring 106 includes a castable metal matrix or deformable materials like FIBERCORE™ stainless steel or an axially deformable lamination. FIBERCORE™ is an ultra-light composite stainless steel available from the Fibretech company.

The intermediate-ring 106 material in one embodiment is cold cured, such as a cold-cured polymer.

Factors for use in selecting or forming a material for the intermediate-ring 106 structure include stiffness, weight, strength, and damping, or ability to absorb energy including mechanical vibrations or noise.

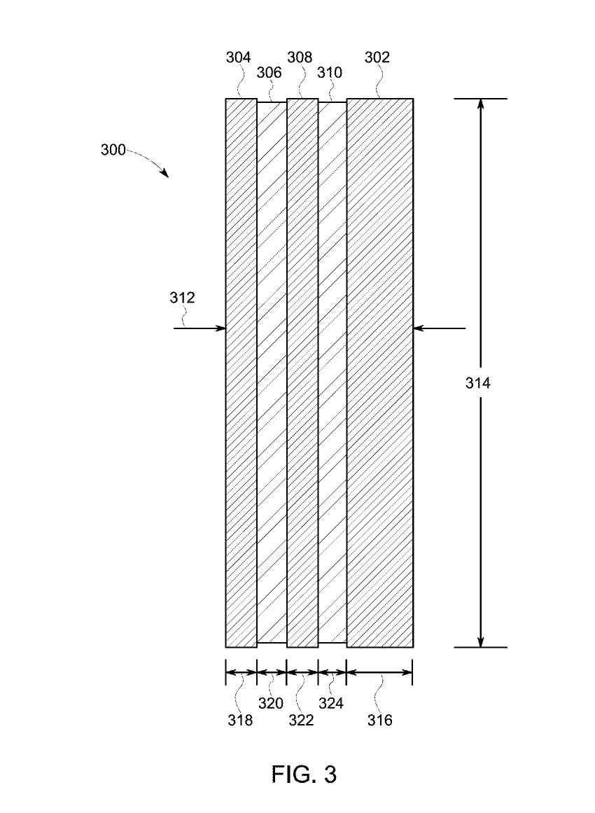

FIG. 3 is a cross-sectional view, like that of FIG. 2, of an alternative barrel structure 300. The embodiment illustrates the alternative barrel 300 comprising more than one damping ring 306, 310 (e.g., polymer) and more than two rigid rings 302, 304, 308 (e.g., steel).

The rings can be selected to have various sizes and materials for accomplishing desired performance.

A thickness 312 is measured between outer and inner surfaces. In one embodiment, the thickness is between about 30 mm and about 170 mm.

In an implementation of the alternative barrel 300, the inner ring 302 is relatively thick, and the other two hard rings 304, 308 are thinner—e.g., relatively thinner steel laminates. As with the primary embodiment of FIG. 2, etc., each hard ring need not be of the same—e.g., they can have different sizes and include different metals or compounds—and each damping ring need not be the same in size or material.

While the rings of the barrel structure 300 can have other thicknesses without departing from the scope of the present technology. In various embodiments, the inner ring 302 has a thickness 316 of between about 10 mm and about 50 mm, the outer ring 304 has a thickness 318 of between about 5 mm and about 30 mm, the outer-most damping, ring 306 has a thickness 320 of between about 5 mm and about 30 mm, the inner-most damping ring 310 has a thickness 324 of between about 5 mm and about 30 mm, and the intermediate hard ring 308 has a thickness 322 of between about 5 mm and about 30 mm.

In one embodiment, a ratio of polymer to outer ring 304 thickness should be maximized. The outer ring 304 is required for protection of the barrel 300, including protecting especially the outermost damping ring 306.

FIG. 4 is a cross-sectional view of the barrel structure, taken along line 4-4 in FIG. 1. The view shows the inner rigid ring 102, the outer rigid ring 104, and the intermediate damping ring 106. The view also shows an inner wall of the inner ring 102 having a connecting shape or structure 402, which is not shown in detail in FIG. 1, but can be considered present there effectively.

The connecting shape or structure 402 is shaped, by way of example, as a dovetail slot. Other potential connector shapes 402 also include slots having a larger interior body and a narrowing opening to hold a mating part (e.g., stator teeth) therein once the mating part is slid into the slot 402.

The connecting shape or structure 402 in contemplated embodiments includes mechanical fastening structure such as screws or weld.

By way of comparison, FIG. 9 shows a barrel 900 that includes a single frame member 902 instead of multiple rings (e.g., rings 102, 104, 106). Stator-teeth-receiving slots 904 are formed in the frame 902. This format is less preferred because the benefits of having an intermediate damping ring (e.g., polyurethane resin) are not achieved.

The benefits of replacing the steel frame 902 with the rings (e.g., rings 102, 104, 106), includes obtaining a light barrel, as the damping ring/s (e.g., 106) and the hard rings (e.g., 102, 104) have less mass combined than the frame 902.

FIG. 5 is a cross-sectional view, like FIG. 4, showing the barrel structure 100 installed with other parts of a stator system 500. The stator system 500 includes a stator 502 comprising stator teeth 504 received in the stator-receiving slots 408. The teeth 504 are surrounded by stator windings 506.

A rotor 510 is opposite the stator 502. The rotor 510 includes rotor-side flux-initiating components 512, such as permanent magnets or similar. Flux, generated during operation of the system 500, are indicated by reference numeral 514.

Dimensions of the stator system 500, and barrel system 100, include a total barrel thickness 520, being a sum of the thicknesses 202, 204, 206 referenced in FIG. 2.

Two radii are also shown, being measured between the respective ring (e.g., outer surface of the ring) and a centerline of the stator system 500 (and so of the stator, rotor, and laminated-barrel rings thereof).

An inner radius 522 extends between the centerline and an inner surface of the inner ring 102, and an outer radius 524 extends between the centerline and an outer surface of the outer ring 104.

With the inner radius 522 being represented by rᵢ and the outer radius 524 represented by rₒ, a second moment of area of the stator can be represented by Iₓ−π/2 (rₒ⁴−rᵢ⁴). The present barrel system 100 is configured to increase this second moment of area. The same relationship and goal applies to other configurations of the technology, such as the barrel 300 shown in FIG. 3. In each case, dimensions are selected with an eye toward increasing the moment, including the ring thicknesses and the overall radii.

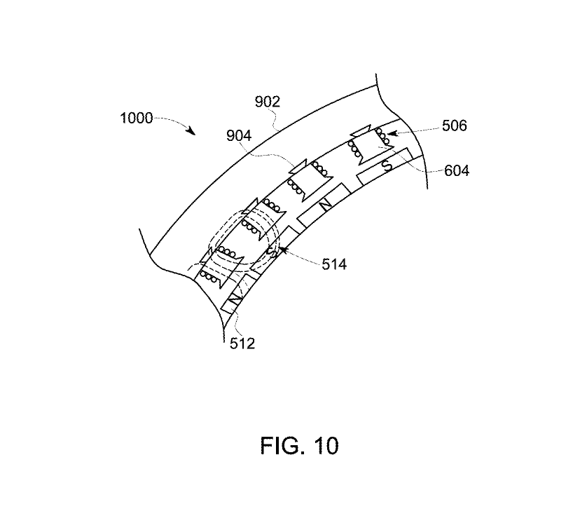

For comparison, FIG. 10 shows a manufactured system 1000 including the barrel structure 900 of FIG. 9.

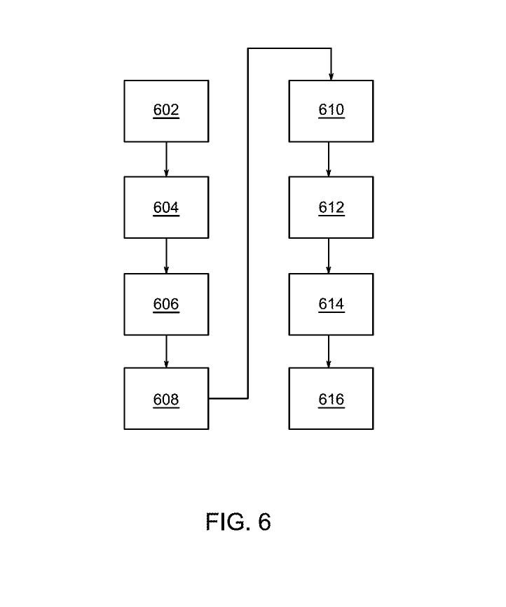

FIG. 6 is a flow chart showing steps for making the barrel structure of the present technology according to example embodiments. Steps of the method can be performed in other orders and one or more of the steps can be omitted without departing from the scope of the present amendment.

A step 602 in creating the laminated barrel of the present technology includes obtaining or forming a relatively large rigid outer ring. In one embodiment, the outer ring 104 is formed using rolled plates, which practice can increase ease and economy (e.g., cost) of forming the outer ring 104 and structure 100.

The outer ring 104 can include either or both of ferrous and non-ferrous metal. Variables for determining whether to use ferrous or non-ferrous include cost and technical specifications.

Another step 604 involves obtaining or forming a relatively smaller rigid inner ring 102, and positioning it inside the outer part. The inner part 102 will form part of a magnetic circuit of the stator-based power generator in which the laminated-barrel structure will be used, and is sized to allow flux, completing a flux circuit.

At a next step 606, the inner and outer parts 102, 104 are aligned. The aligning in some embodiments includes connecting the rings 102, 104, at least temporarily, such as using screws or welding. The aligning can also be performed using a forming fixture. In one embodiment, a welding is made for temporarily locating the rings adjacent each other 102, 104. Screws or other mechanical added connecting parts can be added in addition or instead of welding.

At step 608, or as part of step 606, the inner and outer parts 102, 104 are positioned adjacent a seal, or a seal moved to adjacent the parts 102, 104. The seal(s) 710 can assist in holding the polyurethane to be added to the barrel structure 100 being formed.

In another step 610, the parts are placed in a mold and/or on a table or other surface. For embodiments using seals, the operation can include placing the parts 102, 104 as such with seals on the face with the table or mold base.

The inner and outer rings 102, 104 can be adjusted in the mold position, especially before the rings 102, 2014 are secured together, but also less so after securing and after introduction of the damping material—e.g., polyurethane resin.

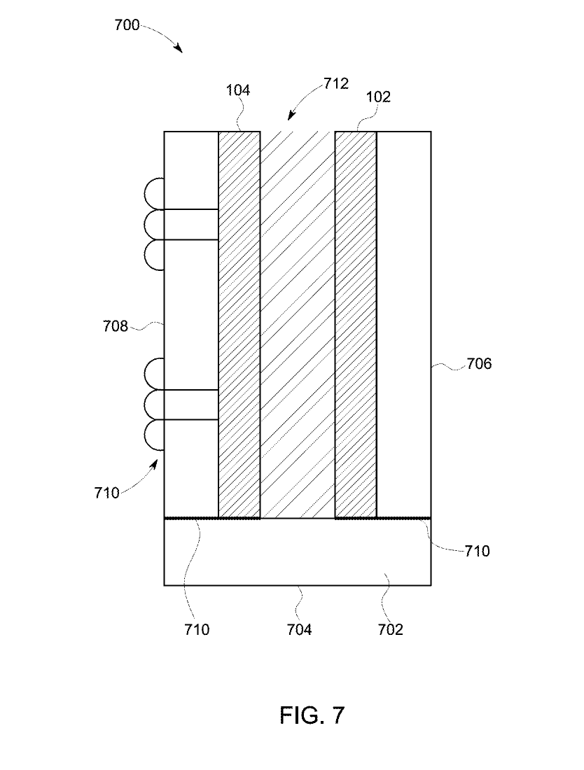

FIG. 7 shows a side cross-sectional view, like the view of FIGS. 2 and 3, of a forming or aligning system 700. The system 700 includes a forming fixture, e.g., at least one forming or aligning mold 702. The mold 702 includes a base 704 and inner and outer uprights 706, 708.

In one embodiment, the table or other surface is used instead of a base 704. The system 700 can include one or more seals 710.

The aforementioned steps form an annular space into which, at step 612, a polyurethane resin or other damping/vibration absorbing material, is poured and cured. The damping material is referenced in FIG. 7 by numeral 712, and yields a damping ring—e.g., ring 106 of FIGS. 1 and 2.

The damping material can be referred to as an infill material, e.g., infill polyurethane resin. This laminates the barrel, yielding the laminated barrel, e.g., laminated-barrel structure 100.

At step 614, the damping material is cured, such as cold cured. In the case of polymer, the damping ring can be said to include cold-cured polymer.

At step 616, the resulting laminated barrel can be connected to a stator structure. An example of the combination is shown in FIG. 5.

The same general technique is used to produce the multiple hard-ring structure 300, shown in FIG. 3.

The laminated barrel (e.g., 100, 300) can be formed without machining and requires no machining after being formed. With the added damping material, the structural response under resonance conditions is limited, resulting in lowered vibration and noise.

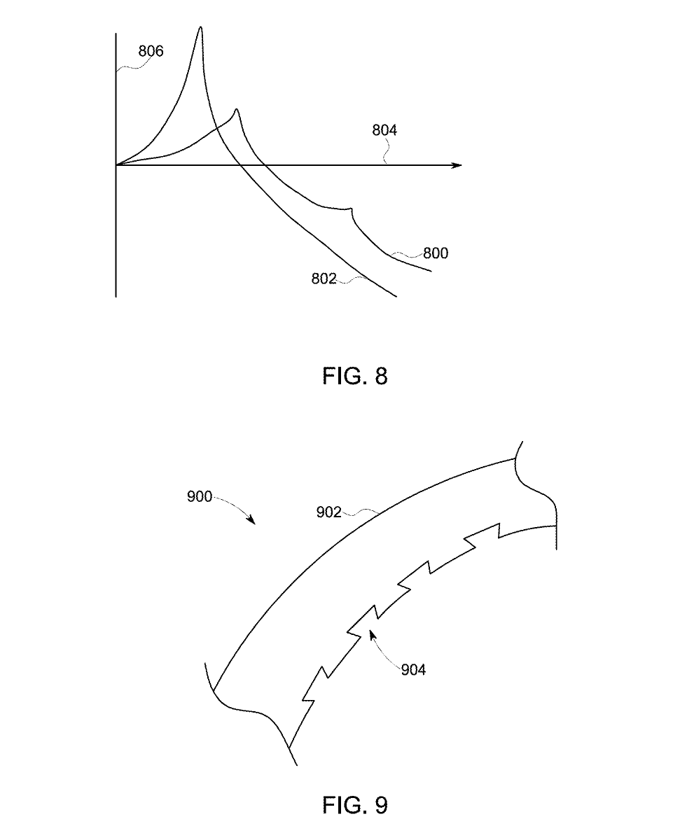

An example vibration response curve 800 for a system according to the present technology is shown in FIG. 8, such as the laminated-barrel structure 100, 300 used in a stator system 500.

A curve according to another technology is referenced by numeral 802.

The curves 800, 802 are shown against an x-axis of input frequency 804, input to the system, measured in, e.g., Hertz (Hz), and a y-axis of response 806, measured in, e.g., acceleration (e.g., m/s²).

The damping-material ring(s) and hard rings can be configured (e.g., size of rings, number of damping rings, number of hard rings, etc.) to achieve desired stiffness, absorbing characteristics, etc., during operation.

In one embodiment, the structure (e.g., barrel structure 100, 300) is made to achieve good separation between first and second resonances. As a quantitative example, the separation between the first and second resonances can be quantified as being greater than about 60% of the value of the first peak.

The separation is shown in FIG. 8 by the difference between the two maximum response points.

The damping level is therefore maximum, whilst adding significant stiffness, and without much added mass.

A benefit of the technology is that the stator system (e.g., system 500 of FIG. 5) is made stiffer, more robust, and to have better damping characteristics than conventional stator structures, without adding heavy mass, stiffeners, or other significant elements to the stator.

The stator systems according to the present technology thus operate smoother and quieter, producing less noise pollution to the environment in which the generator is used (e.g., a city neighborhood or country side).

Also due to the damping functions of the present technology, generator components and intra-generator connections are kept from damage that would otherwise result from unwanted resonations over time.

Stator systems including the present technology are also less susceptible to slight misalignments or misdistributions of mass. They continue to absorb inputs (vibrations, shock, etc.) and avoid unwanted resonation even when the stator is or becomes slightly misaligned or its mass misdistributed.

Other benefits include avoiding the material, work, time, and other relatively-high costs associated with contemplated ameliorative techniques, such as the aforementioned addition of a heavy mass (e.g., large circular part) to the stator. Notably, the present manufacturing technique is relatively inexpensive compared to conventional efforts to address the vibration problem.

The laminated barrel (e.g., 100, 300) can be formed without machining and requires no machining after being formed. With the added damping material, the structural response under resonance conditions is limited, resulting in lowered vibration and noise.

The systems formed according to the present technology can also be made, in at least some embodiments, for less cost, such as by avoiding material, part, energy, tooling, and time costs of obtaining, or making, and installing relatively large rigid masses to an already large stator frame. And without the relatively large added mass and already large conventional stator frame, the resulting barrel structure and stator system are lighter, more efficient, and more maneuverable than other stator frames and stator systems.

Use of plates to make rolled plates to form the hard rings—e.g., 102, 104, 302, 304, 308—can increase ease and economy (e.g., cost) of forming the structure—e.g., structure 100 or 300.

Some conventional manufacturing processes for making larger stator structures involve mechanical segmentation, being relatively complex, expensive and time and space consuming, such as in a gearless mill drive process. The present laminated-barrel structure (e.g., 100, 300 of FIG. 1, 2, 3) or the resulting system (e.g., 500 of FIG. 5), can be made much more easily, and at a local, on site, using, e.g., plate elements of modular form. And furthermore, rings of the laminated-barrel structure resulting from the technique can be aligned using simple form tooling and welding or screws.

Alternative embodiments, examples, and modifications which would still be encompassed by the technology may be made by those skilled in the art, particularly in light of the foregoing teachings. Further, it should be understood that the terminology used to describe the technology is intended to be in the nature of words of description rather than of limitation.

Those skilled in the art will also appreciate that various adaptations and modifications of the preferred and alternative embodiments described above can be configured without departing from the scope and spirit of the technology. Therefore, it is to be understood that, within the scope of the appended claims, the technology may be practiced other than as specifically described herein.

What is claimed is:

1. A laminated-barrel structure, for use in a permanent-magnet power-generation system, comprising:
a rigid outer ring;
a rigid inner ring being smaller in diameter, positioned within, and concentric with the rigid outer ring; and
a damping intermediate ring positioned between the rigid outer ring and the rigid inner ring.

2. A laminated-barrel structure according to claim 1, wherein the intermediate ring includes a polymer.

3. A laminated-barrel structure according to claim 1, wherein the intermediate ring includes a polymer resin.

4. A laminated-barrel structure according to claim 1, wherein at least one of the rigid outer ring and the rigid inner ring includes a metal.

5. A laminated-barrel structure according to claim 4, wherein at least one of the rigid outer ring and the rigid inner ring includes steel.

6. A laminated-barrel structure according to claim 1, further comprising:
a rigid interior ring positioned adjacent and in contact with the rigid inner ring; and
a damping interior ring positioned between and in contact with the rigid interior ring and the rigid outer ring

7. A laminated-barrel structure according to claim 1, wherein the rigid inner ring includes recesses for receiving stator components of the power-generation system.

8. A laminated-barrel structure according to claim 1, wherein the rings are configured to achieve a second moment of area of above about 2 m⁴, wherein:
the second moment of area of the stator is represented by Iₓ=π/2 (rₒ⁴−rᵢ⁴);
rᵢ is an inner radius, measured between the inner rigid ring and a centerline of the permanent-magnet power generation system when assembled; and
rₒ is an outer radius, measured between the outer rigid ring and a centerline of the permanent-magnet power generation system when assembled.

9. A laminated-barrel structure according to claim 1, wherein the rings are configured so that a first resonance and a second resonance are separated by more than about 60% of the value of the first resonance.

10. A permanent-magnet power-generation system, comprising:
a rotor;
a stator positioned adjacent the rotor; and
a laminated-barrel structure connected to the stator and comprising:
a rigid outer ring;
a rigid inner ring; and
a damping intermediate ring intermediate the rigid outer ring and the rigid inner ring.

11. A permanent-magnet power-generation system according to claim 10, wherein:
the rigid inner ring is smaller than, positioned within, and concentric with the rigid outer ring; and
the damping intermediate ring is positioned between and in contact with the rigid outer ring and the rigid inner ring.

12. A permanent-magnet power-generation system according to claim 10, wherein:
the intermediate ring includes polymer; and
at least one of the rigid outer ring and the rigid inner ring includes a metal.

13. A permanent-magnet power-generation system according to claim 10, further comprising:
an interior rigid ring positioned adjacent and in contact with the rigid inner ring; and
a damping interior ring positioned between and in contact with the interior rigid ring and the rigid outer ring

14. A permanent-magnet power-generation system according to claim 10, wherein:
the stator includes stator teeth; and
the rigid inner ring includes recesses for receiving the stator teeth.

15. A permanent-magnet power-generation system according to claim 10, wherein the rings are configured to achieve a second moment of area of above about 2 m⁴, wherein:
the second moment of area of the stator is represented by Iₓ=π/2 (rₒ⁴−rᵢ⁴);
rᵢ is an inner radius, measured between the inner ring and a centerline of the permanent-magnet power generation system when assembled; and
rₒ is an outer radius, measured between the outer ring and a centerline of the permanent-magnet power generation system when assembled.

16. A permanent-magnet power-generation system according to claim 10, wherein the rings are configured so that a first resonance and a second resonance are separated by greater than about 60% of the value of the first resonance.

17. A method of forming a laminated-barrel structure, for use in a permanent-magnet power-generation system, the method comprising:
positioning a rigid outer ring adjacent and around a rigid inner ring; and
introducing a damping material intermediate the rigid outer ring and the rigid inner ring.

18. A method according to claim 17, further comprising connecting together, following the positioning, and prior to the introducing, the rigid outer ring and the rigid inner ring.

19. A method according to claim 17, further comprising positioning the rigid outer ring and the rigid inner ring in a barrel mold prior to introducing the damping material.

20. A method according to claim 17, wherein:
the method further comprises positioning a rigid interior ring adjacent and intermediate the rigid outer ring and the rigid inner ring; and
introducing the damping material intermediate the rigid outer ring and the rigid inner ring comprises introducing the damping material both between the rigid inner ring and the interior rigid ring and between the interior rigid ring and the rigid outer ring.
